(19) United States
(12) Patent Application Publication
(10) Pub. No.: US 2006/0133356 A1
(43) Pub. Date: Jun. 22, 2006

(54) Network telephone system

(75) Inventor: Rumi Suzukawa, Hino-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/289,310

(22) Filed: Nov. 30, 2005

(30) Foreign Application Priority Data
Nov. 30, 2004 (JP) P2004-346564

(51) Int. Cl. H04L 12/66

(52) U.S. Cl. 370/352

(57) ABSTRACT

An SIP server continuously monitors the registration information of each of SIP terminals in a terminal registration state table. When the registration state of the SIP terminal is changed to “unregistered” as the Expires date is exceeded or a failure occurs in the SIP server, the SIP server transmits a REGISTER request message to the SIP terminal. When REGISTER comes from the SIP terminal in response to the REGISTER request message, the SIP server again sets the registration state of the SIP terminal in the terminal registration state table to “registered.”

### RELATED APPLICATIONS

The present disclosure relates to the subject matter contained in Japanese Patent Application No. 2004-346564 filed on Nov. 30, 2004, which is incorporated herein by reference in its entirety.

### BACKGROUND

1. Field of the Invention

The present invention relates to a network telephone system for conducting voice communications between telephone terminals through an IP network, such as a VoIP (Voice Over Internet Protocol) telephone system, and a server and a telephone terminal of the network telephone system.

2. Description of the Related Art

in recent years, a network telephone system (VoIP telephone system) for transmitting and receiving an image and voice as packet data bidirectionally through a packet network has begun to come into widespread use. In the VoIP telephone system, SIP (Session Initiation Protocol) is widely used as the protocol of the telephone system.

In the network telephone system of the above-described kind, the address of a terminal connected to the packet network, which will be hereinafter referred to as SIP terminal, is previously registered in a server on the packet network, which will be hereinafter referred to as SIP server, and when conversation is made between the SIP terminals, the SIP server authenticates the SIP terminals based on the registered addresses.

In the described system, although the addresses are registered in the SIP server, the registered addresses may become unregistered under the following circumstances causing the conversation between the telephone terminals unavailable:

(1) After the Expires (message expiration) date, re-REGISTER from an SIR terminal cannot reach the SIP server due to a temporary network failure, and the SIP terminal becomes unregistered in the SIP server.

(2) When a failure occurs in the SIP server, SIP terminal registration/non-registration information is erased, and all registered SIP terminals become unregistered in the SIP server.

In the above two cases, unless the unregistered SIP terminal is rebooted and issues REGISTER to the SIP server, the SIP terminal is left unregistered for a long time. Accordingly, it becomes unavailable for the SIP terminal to make and receive a call.

In order to overcome the problem above, there is proposed a technique of sending an incoming command from the SIP server to each SIP terminal at given time intervals and causing the SIP terminal to again register the address (For example, refer to JP-A-2003-304345).

### SUMMARY

However, in the conventionally proposed technique, an incoming command is always sent from the SIP server to every one of the SIP terminals at given time intervals and thus the processing load on the SIP server increases. In addition, when the address of the SIP terminal becomes unregistered, the unregistered SIP terminal cannot be registered again in real time.

The present invention provides a network telephone system that a telephone terminal that became an unregistered state in a server can be promptly restored to a registered state, and a server and a telephone terminal for use in the network telephone system.

A network telephone system includes: a plurality of telephone terminals connected to a communication network for transmitting a voice packet; and a server for connecting the plurality of telephone terminals through the communication network and allowing the plurality of telephone terminals to communicate with each other. The server includes: a storage unit that stores in a recording medium a plurality of pieces of registration information indicating that communications are available to be conducted through the communication network in association with identification information indicating each of the plurality of telephone terminals connected to the communication network; a detection unit that detects whether or not at least one of the plurality of pieces of registration information stored in the recording medium has been erased; a request transmission unit that transmits, when the detection unit detects that at least one of the plurality of pieces of registration information is erased, a registration information acquisition request to the telephone terminal corresponding to the erased registration information; and a processing unit that receives the registration information and the identification information sent from the requested telephone terminal in response to the registration information acquisition request and recording the registration information and the identification information in the recording medium. Each of the plurality of telephone terminals comprises an information transmission unit that transmits the registration information together with the identification information to the server in response to the acquisition request when the acquisition request is sent from the server.

A server is for use in a network telephone system having a plurality of telephone terminals connected to a communication network to transmit a voice packet, and for connecting the plurality of telephone terminals through the communication network and allowing the plurality of telephone terminals to communicate with each other. The server includes: a storage unit that stores in a recording medium a plurality of pieces of registration information indicating that communications are available to be conducted through the communication network in association with identification information indicating each of the plurality of telephone terminals connected to the communication network; a detection unit that detects whether or not at least one of the plurality of pieces of registration information stored in the recording medium has been erased; a request transmission unit that transmits, when the detection unit detects that at least one of the plurality of pieces of registration information is erased, a registration information acquisition request to the telephone terminal corresponding to the erased registration information; and a processing unit that receives the registration information and the identification information sent from the requested telephone terminal in response to the registration information acquisition request and recording the registration information and the identification information in the recording medium.

A telephone terminal is for use in a network telephone system including: a plurality of the telephone terminals connected to a communication network; and a server for connecting the plurality of telephone terminals through the communication network and allowing the plurality of telephone terminals to communicate with each other. The telephone terminal includes; a voice packet processing unit that converts a voice signal and a voice packet into one another for transmitting the voice packet through the communication network; and an information transmission unit that transmits the registration information together with the identification information to the server in response to the acquisition request when the acquisition request is sent from the server.

### BRIEF DESCRIPTION OF THE DRAWINGS

In the accompanying drawings:

FIG. 1 is a drawing to show the schematic configuration of a first embodiment of a network telephone system;

FIG. 2 is a block diagram to show the function configuration of an SIP server of the first embodiment;

FIG. 3 is a drawing to show an example of the storage contents of a terminal information table shown in FIG. 2;

FIG. 4 is a drawing to show an example of the storage contents of a terminal registration state table shown in FIG. 2;

FIG. 5 is a block diagram to show the function configuration of an SIP terminal of the first embodiment;

FIG. 6 is a flowchart to show a processing procedure of the SIP server when each SIP terminal is registered in the SIP server in the first embodiment;

FIG. 7 is a drawing to describe the operation of the SIP terminal to give a registration command to the SIP server;

FIG. 8 is a drawing to describe the operation of the SIP terminal to give a registration refusal command to the SIP server;

FIG. 9 is a flowchart to show a control procedure of the SIP server when the SIP terminal that became unregistered is registered in the first embodiment;

FIG. 10 is a flowchart to show a control procedure of the SIP terminal in the first embodiment;

FIG. 11 is a block diagram to show the function configuration of an SIP server as a second embodiment; and

FIG. 12 is a drawing to describe a processing flow between the SIP server and an SIP terminal when a conversation request is made from the SIP terminal that became unregistered in the second embodiment.

### DETAILED DESCRIPTION OF THE EMBODIMENTS

Referring now to the accompanying drawings, there are shown preferred embodiments of the invention.

### First Embodiment

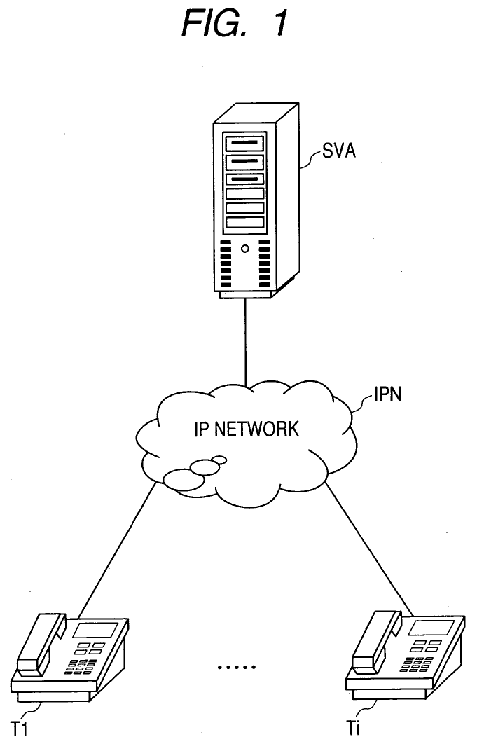

FIG. 1 is a drawing to show the schematic configuration of a first embodiment of a network telephone system.

The system is connected to an IP network IPN. A plurality of SIP terminals T1 to Ti (i is a natural number) are connected to the IP network IPN. An SIP server SVA is connected to the IP network XPN. The SIP server SVA is provided with an assignment function for assigning IP addresses to the SIP terminals T1 to Ti, a call control function for controlling a call made between the SIP terminals T1 to Ti, and a management function for managing the addresses assigned to the SIP terminals T1 to Ti.

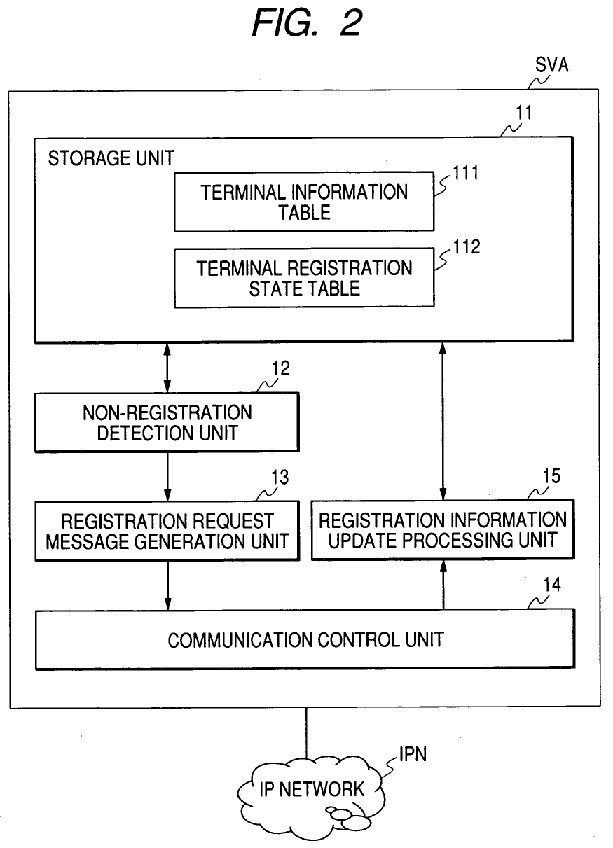

FIG. 2 is a block diagram to show the configuration of the SIP server SVA.

The SIP server SVA includes a storage unit 11 implemented as a nonvolatile recording medium, a for example, that became unregistered.

The communication control unit 14 allows the SIP terminals T1 to Ti to communicate with each other through the IP network IPN. The communication control unit 14 sends the REGISTER request message to the SIP terminal T2 and receives REGISTER as registration information transmitted by the SIP terminal T2 in response to the REGISTER request. The REGISTER contains a message for requesting the SIP terminal to register the address and the URI and IP address of the SIP terminal T2.

When REGISTER is sent from the SIP terminal T2, the registration information update processing unit 15 updates the registration state corresponding to the SIP terminal T2 in the terminal registration state table 112 from “unregistered” to “registered” in accordance with the descriptions of the REGISTER.

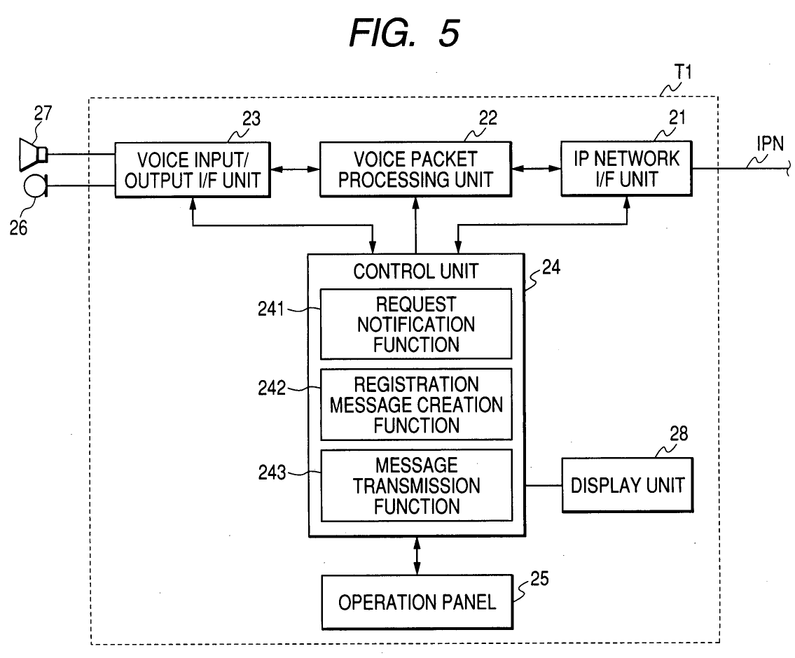

FIG. 5 is a block diagram to show the configuration of each of the SIP terminals T1 to Ti. Hereinbelow, the SIP terminal T1 will be discussed as a representative.

The SIP terminal T1 includes an IP network interface (I/F) unit 21, a voice packet processing unit 22, a voice input/output interface (I/F) unit 23, a control unit 24, and an operation panel 25.

The IP network interface unit 21 performs the interface operation concerning the IP network IPN. That non-registration detection unit 12, a registration request message generation unit 13, a communication control unit 14, and a registration information update processing unit 15.

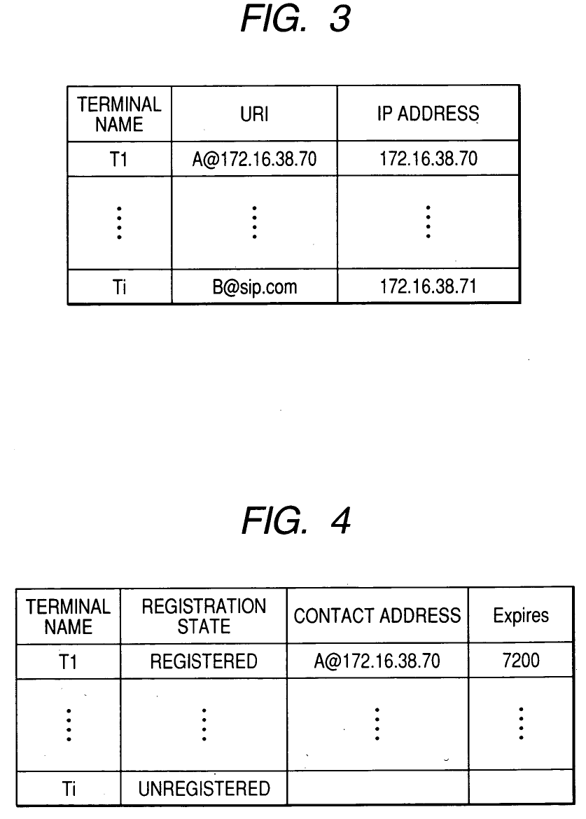

The storage unit 11 is provided with a terminal information table 111 and a terminal registration state table 112. The terminal information table 111 stores URI (Uniform Resource Identifier) and IP addresses in association with the SIP terminals T1 to Ti, as shown in FIG. 3. The terminal registration state table 112 stores information indicating the registration state, contact addresses, and Expires date information indicating the registration expiration date in association with the SIP terminals T1 to Ti, as shown in FIG. 4.

The non-registration detection unit 12 detects whether or not the registration state in the terminal registration state table 112 is changed from registered state to unregistered state. When the non-registration detection unit 12 detects that the registration state in the terminal registration state table 112 is changed from registered to unregistered, the registration request message generation unit 13 generates a message to the effect that the registration state is changed from registered to unregistered and a REGISTER request message containing the URI and IP address of an SIP terminal T2, is, the IP network interface unit 21 extracts a voice packet and control data from a transmission packet sent from the IP network IPN and gives the voice packet to the voice packet processing unit 22 and the control data to the control unit 24. The IP network interface unit 21 transmits a voice packet given from the voice packet processing unit 22 and data given from the control unit 24 to the IP network IPN.

The voice packet processing unit 22 converts the voice packet given from the IP network interface unit 21 into an analog reception voice signal and gives the voice signal to the voice input/output interface unit 23. The voice packet processing unit 22 converts a transmission voice signal input from the voice input/output interface unit 23 into a voice packet that can be handled in the IP network IPN and gives the voice packet to the IP network interface unit 21.

A microphone 26 and a speaker 27 are connected to the voice input/output interface unit 23. The voice input/output interface unit 23 inputs a transmission voice signal input through the microphone 26 to the voice packet processing unit 22 and outputs the reception voice signal output from the voice packet processing unit 22 from the speaker 27.

The control unit 24 controls the units of the SIP terminal T1 and performs communication processing with the IP network IPN by software processing.

The operation panel 25 is provided with key switches and accepts various command entries of the user for the control unit 24. A display unit 28 is provided with a display device such as an LCD panel, and provides the user with various pieces of information.

The control unit 24 provides a plurality of functions of a request notification function 241, a registration message creation function 242, and a message transmission function 243. When a REGISTER request message comes from the SIP server SVA, the request notification function 241 displays a message to the effect that a REGISTER request message comes, together with URI and IP address on the display unit 28.

The registration message creation function 242 generates REGISTER for the SIP server SVA in response to a registration command entered through the operation panel 25. The message transmission function 243 sends the generated REGISTER to the SIP server SVA. When a command for refusing registration is entered through the operation panel 25, the registration message creation function 242 generates an error message such as “481 Subscription does not exist”.

Next, the processing operation in the configuration described above will be discussed.

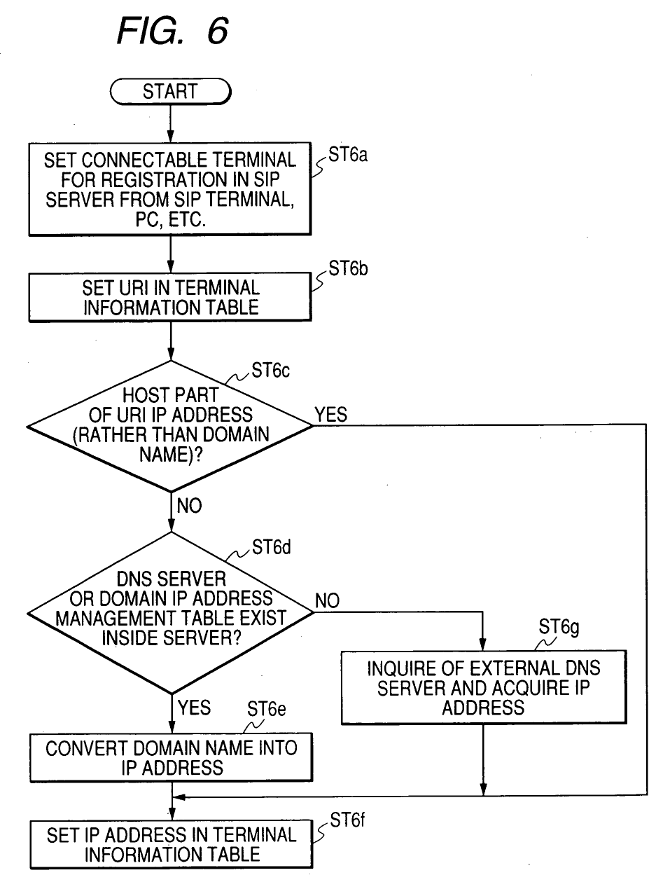

FIG. 6 is a flowchart to show a processing procedure of the SIP server SVA when each of the SIP terminals T1 to Ti is registered in the SIP server SVA.

For example, when connection for registering the SIP terminal T1 is made from the SIP terminal T1 or a personal computer (step ST6a), the SIP server SVA sets URI of the SIP terminal T1 in the terminal information table 111 (ST6b) and determines whether or not the host part of URI is IP address (step ST6c).

When the host part of URI is not IP address (NO at step ST6c), the SIP server SVA determines whether or not an IP address management table exists inside the server (step ST6d). When the IP address management table exists inside the server, the SIP server SVA references the IP address management table and converts the domain name into IP address (step ST6e) and registers the IF address in the terminal information table 111 (step ST6f).

When the IP address management table does not exist inside the server, the SIP server SVA inquires of an external DNS server and acquires IP address (step ST6g).

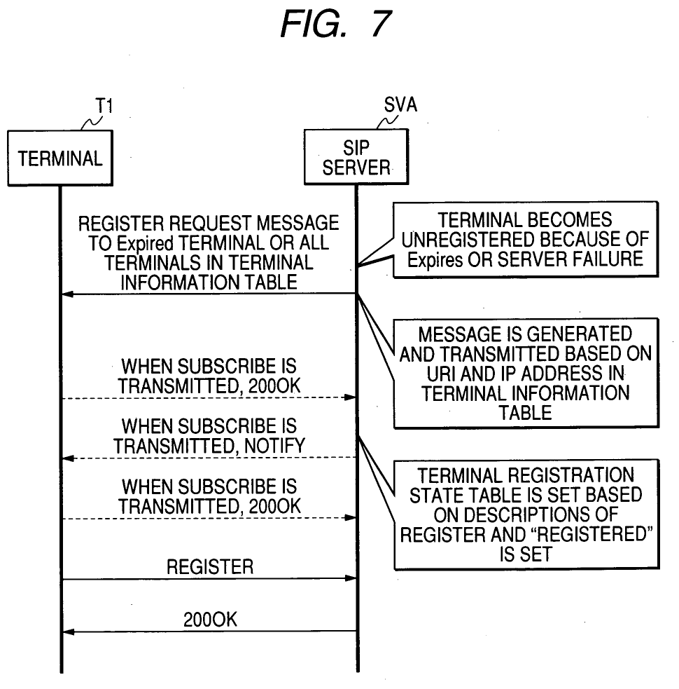

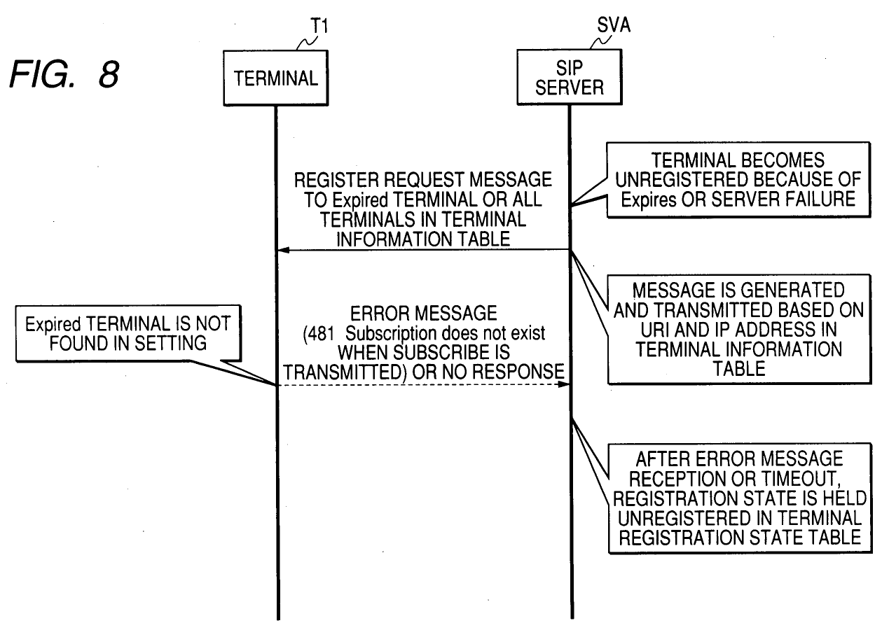

Next, a processing flow between the SIP server SVA and the SIP terminal T1 to Ti when the SIP terminal T1 to Ti that became unregistered is registered will be discussed with reference to FIGS. 7 and 8. FIG. 7 shows an example wherein the SIP terminal T1 gives a registration command to the SIP server SVA, and FIG. 8 shows an example wherein the SIP terminal T1 gives a registration refusal command to the SIP server SVA. In the description to follow, it is assumed that the registration state, the contact addresses, and the Expires date information about the SIP terminals T1 to Ti are already set in the terminal registration state table 112.

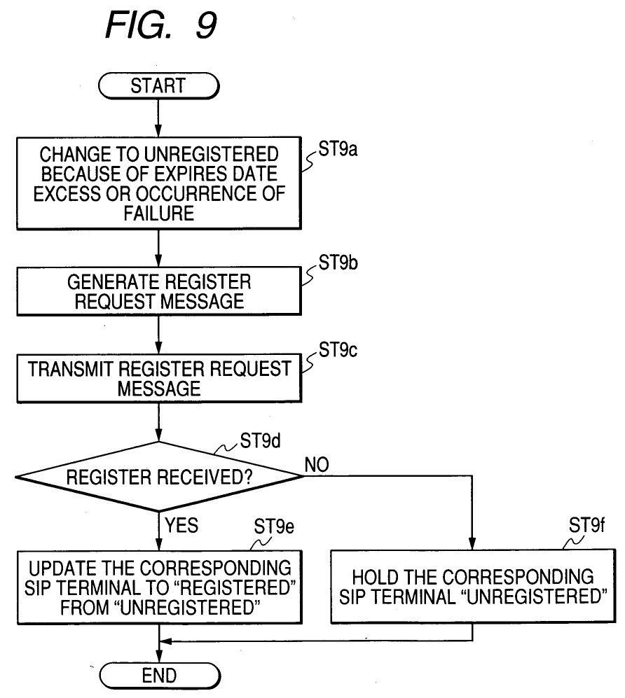

To register the SIP terminal T1 to Ti that became unregistered, the SIP server SVA executes a processing procedure shown in FIG. 9.

The SIP server SVA monitors the registration state of each of the SIP terminals T1 to Ti in the terminal registration state table 112. When the Expires date is exceeded or a failure occurs in the SIP server SVA and the registration state of the SIP terminal T1, for example, is changed from “registered” to “unregistered” (step ST9a), the SIP server SVA generates a REGISTER request message containing the URI and IP address of the SIP terminal T1 (step ST9b). The SIP server SVA transmits the generated REGISTER request message to the SIP terminal T1 (step ST9c).

Subsequently, the SIP server SVA checks whether or not REGISTER is sent from the SIP terminal T1 within a given time after transmission of the REGISTER request message (step ST9d). When REGISTER is sent (Yes at step ST9d), the SIP server SVA updates the registration state corresponding to the SIP terminal T1 in the terminal registration state table 112 to “registered” from “unregistered” (step ST9e). After the update, the SIP server SVA transmits a normal termination notification such as “200 OK” that registration processing has been performed normally to the SIP terminal T1.

On the other hand, when an error message is sent from the SIP terminal T1 or REGISTER is not sent within the given time (No at step ST9d), the SIP server SVA holds the registration state corresponding to the SIP terminal T1 “unregistered” in the terminal registration state table 112 (step ST9f).

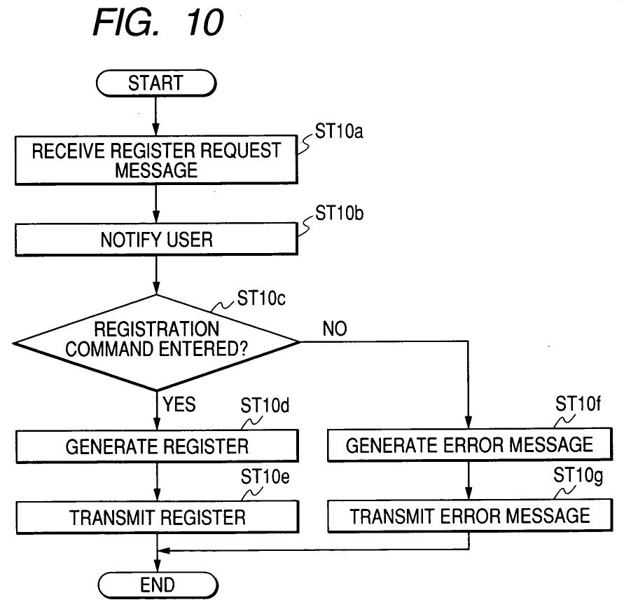

On the other hand, the SIP terminal T1 executes a processing procedure shown in FIG. 10.

That is, upon reception of the REGISTER request message coming from the SIP server SVA (step ST10a) the SIP terminal T1 supplies a message to the effect that the SIP terminal T1 is that became unregistered and the URI and IP address of the SIP terminal T1 to the display unit 28 for displaying the message, the URI, and the IP address (step ST10b). Therefore, the display enables the user to know in real time that the SIP terminal T1 is that became unregistered for some failure.

In this state, assume that the user enters a registration command through the operation panel 25 to register in the SIP server SVA. Then, the SIP terminal T1 proceeds the process to step ST10d from step ST10c and generates REGISTER and transmits REGISTER to the SIP server SVA through the IP network IPN (step 10e). The REGISTER contains the URI and IP address of the SIP terminal T1.

Assume that the user enters a registration refusal command through the operation panel 25 to refuse registration at step ST10C. Then, the SIP terminal T1 proceeds the process to step ST10f from step ST10c and generates an error message and transmits the error message to the SIP server SVA through the IP network IPN (step 10g) The error message contains the URI and IP address of the SIP terminal T1.

As described above, in the first embodiment, the SIP server SVA continuously monitors registration information concerning the SIP terminals T1 to Ti in the terminal registration state table 112. When the registration state of the SIP terminal T1 to Ti is changed to “unregistered” because of “expiration of the Expires date” or failure occurrence of the SIP server SVA, the SIP server SVA transmits a REGISTER request message to the SIP terminal T1 to Ti. When REGISTER comes from the SIP terminal T1 to Ti in response to the REGISTER request message, the SIP server SVA again sets the registration state of the SIP terminal T1 to Ti to “registered” in the terminal registration state table 112.

Therefore, whenever unregistered is detected in the terminal registration state table 112 of the SIP server SVA for some failure, REGISTER can be acquired in real time from the SIP terminal T1 to Ti that became unregistered, so that the SIP terminal T1 to Ti that became unregistered is automatically set to the registered state, enabling the user to make conversation as usual without the need for the user to manually restart the SIP terminal T1 to Ti that became unregistered.

In the first embodiment, whenever the SIP terminal is that became unregistered in the terminal registration state table 112 of the SIP server SVA and a REGISTER request message is sent from the SIP server SVA, the user of the corresponding SIP terminal T1 to Ti determines whether or not registration is required, and gives a command accordingly. Thus, the SIP server SVA can set only the SIP terminal T1 to Ti which needs to be set to registered to registered.

### Second Embodiment

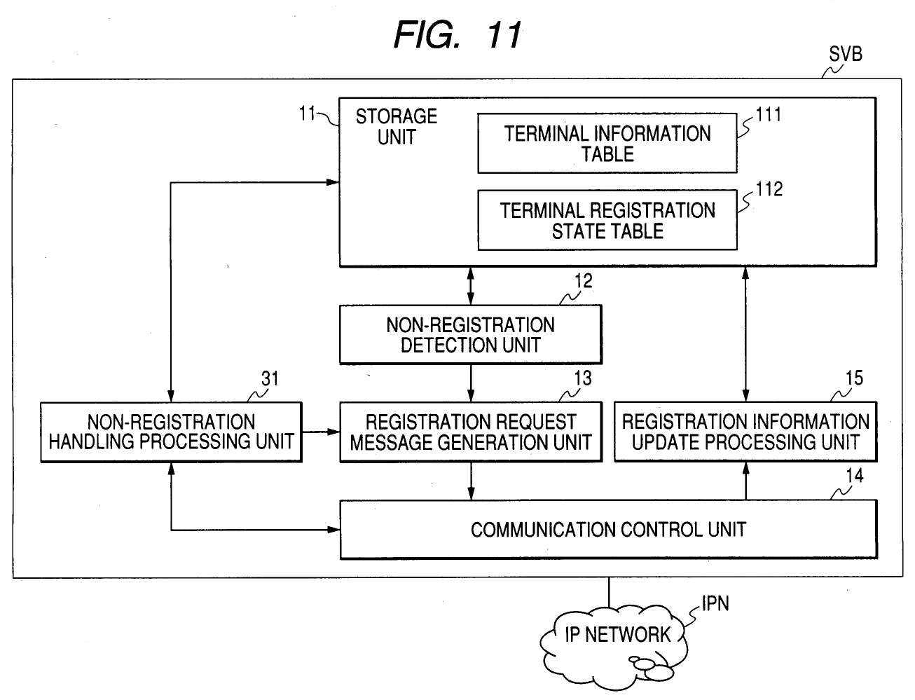

FIG. 11 is a block diagram to show the configuration of an SIP server SVB as a second embodiment. Parts identical with those previously described with reference to FIG. 2 are denoted by the same reference numerals in FIG. 11 and will not be discussed again in detail.

The SIP server SVB is provided with a non-registration handling processing unit 31. When a request to use an IP network IPN (INVITE) is sent from an SIP terminal T2, for example, that became unregistered in a terminal registration state table 112, the non-registration handling processing unit 31 controls a communication control unit 14 to send an error message such as “404 Not Found” indicating that the IP network IPN cannot be used to the SIP terminal T2, and then controls a registration request message generation unit 13 and the communication control unit 14 to send a REGISTER request message.

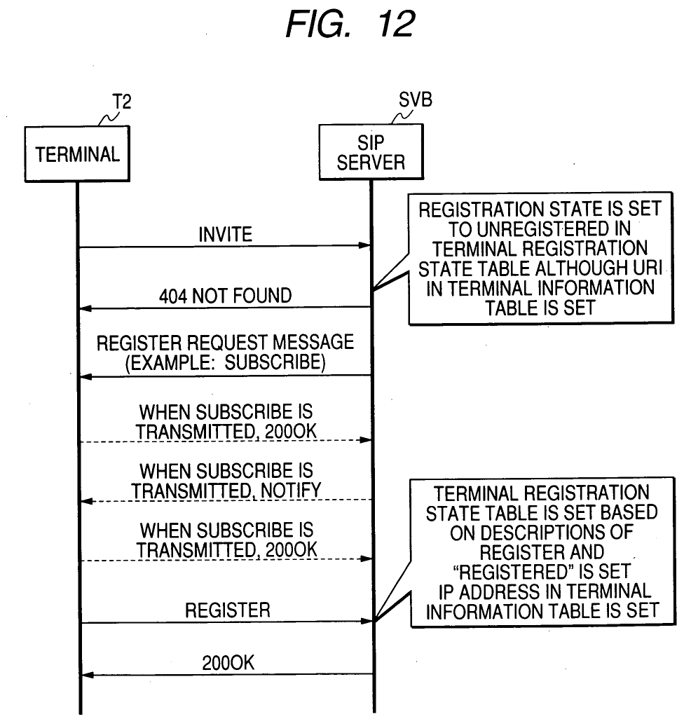

Next, the processing operation in the configuration will be discussed. A processing flow between the SIP server SVB and the SIP terminal T2 when a conversation request is made from the SIP terminal T2 that became unregistered will be discussed with reference to FIG. 12. Here, it is assumed that only the URI of the SIP terminal T2 is set in a terminal information table 111.

That is, upon reception of INVITE from the SIP terminal T2, the SIP server SVB transmits an error message to the SIP terminal T2 and then transmits a REGISTER request message to the SIP terminal T2.

On the other hand, upon reception of the error message coming from the SIP server SVB, the SIP terminal T2 supplies a message to the effect that that the IP network IPN cannot be used and the URI of the SIP terminal T2 to a display unit 28 for displaying them. Therefore, the display enables the user to know that the SIP terminal T2 is already that became unregistered.

Subsequently, upon reception of the REGISTER request message, the SIP terminal T2 supplies a message indicating a registration operation procedure and the URI and IP address of the SIP terminal T2 to the display unit 28 for displaying them. Therefore, the display enables the user to again register the SIP terminal T2 in the SIP server SVB.

In this state, assume that the user enters a registration command through an operation panel 25 to register in the SIP server SVB. Then, the SIP terminal T2 generates REGISTER and transmits REGISTER to the SIP server SVB through the IP network IPN. The REGISTER contains the URI and IP address of the SIP terminal T2.

As described above, according to the second embodiment, to use the SIP terminal T2 once that became unregistered, the message to the effect that the IP network IFN cannot be used and the REGISTER request message to again register are sent from the SIP server SVB to the SIP terminal T2, so that the user can acknowledge that the SIP terminal T2 to be used is unregistered, and sends REGISTER to the SIP server SVB in accordance with the REGISTER request message, whereby the user can again make conversation at the SIP terminal T2.

As described above with reference to the embodiments, there is provided a network telephone system having: a plurality of telephone terminals connected to a communication network for transmitting a voice packet; and a server for connecting the plurality of telephone terminals through the communication network and allowing the plurality of telephone terminals to communicate with each other. The server includes: a storage unit (the storage unit 11) that stores in a recording medium a plurality of pieces of registration information indicating that communications are available to be conducted through the communication network in association with identification information indicating each of the plurality of telephone terminals connected to the communication network; a detection unit (the non-registration detection unit 12) that detects whether or not at least one of the plurality of pieces of registration information stored in the recording medium has been erased; a request transmission unit (the registration request message generation unit 13, and the communication control unit 14) that transmits, when the detection unit detects that at least one of the plurality of pieces of registration information is erased, a registration information acquisition request to the telephone terminal corresponding to the erased registration information; and a processing unit (the communication control unit 14, and the registration information update processing unit 15) that receives the registration information and the identification information sent from the requested telephone terminal in response to the registration information acquisition request and recording the registration information and the identification information in the recording medium. Each of the plurality of telephone terminals includes an information transmission unit (the IP network I/F unit 21, and the control unit 24) that transmits the registration information together with the identification information to the server in response to the acquisition request when the acquisition request is sent from the server.

According to the configuration, the registration information of each telephone terminal in the recording medium is continuously monitored. When at least one piece of registration information is that became unregistered, the server sends a registration information acquisition request to the corresponding telephone terminal and when registration information comes from the corresponding telephone terminal in response to the acquisition request, the registration information is again registered in the recording medium of the server.

Therefore, whenever unregistered is detected in the recording medium of the server for some failure, registration information can be acquired in real time from the telephone terminal that became unregistered, so that the telephone terminal that became unregistered is automatically set to the registered state, enabling the user to make conversation as usual without the need for the user to manually restart the telephone terminal that became unregistered.

The server may be configured that the storage unit stores expiration date information that indicates expiration date of the registration information in association with the identification information in addition to the registration information, wherein the detection unit detects that the registration information is erased from the recording medium according to the expiration date information, and wherein when the registration information is erased from the recording medium, the request transmission unit transmits a registration information acquisition request to the corresponding telephone terminal.

According to the configuration, when the registration information is erased from the recording medium according to the expiration date information managed in the recording medium by the server, the server transmits a registration information acquisition request to the corresponding telephone terminal, whereby the telephone terminal that became unregistered is automatically set to the registered state, enabling the user to make conversation as usual.

The network telephone system may be configured that when the acquisition request is sent from the server, the information transmission unit of the telephone terminal transmits a refusal signal for refusing registration to the server as required, and wherein upon reception of the refusal signal sent from the requested telephone terminal, the processing unit of the server sets the corresponding telephone terminal to an unregistered state.

According to the configuration, whenever the telephone terminal is that became unregistered in the recording medium of the server and a registration information acquisition request is sent from the server, the user of the corresponding telephone terminal can determine whether or not registration is required, and can give a command accordingly. Thus, it is made possible to set to be registered only the telephone terminal that needs to be set.

The server may be configured that when the registration information and the identification information are unable to be received from the corresponding telephone terminal within a predetermined time period from the timing of sending the acquisition request, the processing unit sets the corresponding telephone terminal to an unregistered state.

According to the configuration, when the registration information and the identification information cannot be received from the corresponding telephone terminal within the predetermined time from the sending timing of the acquisition request, the corresponding telephone terminal can be determined to be unused and can be set to unregistered.

The server may further include; an error transmission unit (the communication control unit 14) that sends a registration information acquisition request after sending an error message indicating that the communication network is unavailable to be used to the requesting telephone terminal when a request to use the communication network is sent from the telephone terminal being recorded in the recording medium as an unregistered state, and wherein when the registration information and the identification information are sent from the requested telephone terminal in response to the registration information acquisition request, the processing unit records the registration information in the recording medium in association with the corresponding identification information.

According to the configuration, to use the telephone terminal once that became unregistered, the user can check that the telephone terminal to be used is unregistered. At the time, the server sends a registration information acquisition request to the corresponding telephone terminal, so that the user sends the registration information to the server in accordance with the acquisition request, whereby the user can again make conversation at the telephone terminal.

As described above in detail, according to the invention, there is provided the network telephone system wherein when one of the telephone terminal is that became unregistered in the server, it can be promptly restored to the registered state, and the server and the telephone terminal of the network telephone system.

In the above described embodiments, there is described an example using the terminal information table and the terminal registration state table. However, the network telephone system may be configured that only the terminal registration state table is used.

The network telephone system according to the embodiments may be configured that, when the REGISTER request message is sent, REGISTER may be automatically sent from the SIP terminal to the SIP server for updating the corresponding registration state to “registered.”

In the description of each of the embodiments described above, the network telephone system using the SIP is taken as an example. However, the present invention may also be applied to any system other than the SIP.

The types and configurations of the server and the telephone terminals, the control procedures of the server and the telephone terminals to again register, and the like can be modified in various manners without departing from the spirit and scope of the present invention.

It is to be understood that the present invention is not limited to the embodiments described above and that the invention can be embodied with the components modified without departing from the spirit and scope of the invention. The present invention can be embodied in various forms according to appropriate combinations of the components disclosed in the embodiment described above. For example, some components may be deleted from all components shown in the embodiment. Further, the components in different embodiments may be used appropriately in combination.

What is claimed is:

1. A network telephone system comprising:
a plurality of telephone terminals connected to a communication network for transmitting a voice packet; and
a server for connecting the plurality of telephone terminals through the communication network and allowing the plurality of telephone terminals to communicate with each other,
wherein the server comprises:
a storage unit that stores in a recording medium a plurality of pieces of registration information indicating that communications are available to be conducted through the communication network in association with identification information indicating each of the plurality of telephone terminals connected to the communication network;
a detection unit that detects whether or not at least one of the plurality of pieces of registration information stored in the recording medium has been erased;
a request transmission unit that transmits, when the detection unit detects that at least one of the plurality of pieces of registration information is erased, a registration information acquisition request to the telephone terminal corresponding to the erased registration information; and
a processing unit that receives the registration information and the identification information sent from the requested telephone terminal in response to the registration information acquisition request and recording the registration information and the identification information in the recording medium, and
wherein each of the plurality of telephone terminals comprises an information transmission unit that transmits the registration information together with the identification information to the server in response to the acquisition request when the acquisition request is sent from the server.

2. The network telephone system according to claim 1, wherein the storage unit stores expiration date information that indicates expiration date of the registration information in association with the identification information in addition to the registration information,
wherein the detection unit detects that the registration information is erased from the recording medium according to the expiration date information, and
wherein when the registration information is erased from the recording medium, the request transmission unit transmits a registration information acquisition request to the corresponding telephone terminal.

3. The network telephone system according to claim 1, wherein when the acquisition request is sent from the server, the information transmission unit of the telephone terminal transmits a refusal signal for refusing registration to the server as required, and
wherein upon reception of the refusal signal sent from the requested telephone terminal, the processing unit of the server sets the corresponding telephone terminal to an unregistered state.

4. The network telephone system according to claim 1, wherein when the registration information and the identification information are unable to be received from the corresponding telephone terminal within a predetermined time period from the timing of sending the acquisition request, the processing unit sets the corresponding telephone terminal to an unregistered state.

5. The network telephone system according to claim 1, wherein the server further comprises:
an error transmission unit that sends a registration information acquisition request after sending an error message indicating that the communication network is unavailable to be used to the requesting telephone terminal when a request to use the communication network is sent from the telephone terminal being recorded in the recording medium as an unregistered state, and
wherein when the registration information and the identification information are sent from the requested telephone terminal in response to the registration information acquisition request, the processing unit records the registration information in the recording medium in association with the corresponding identification information.

6. A server for use in a network telephone system having a plurality of telephone terminals connected to a communication network to transmit a voice packet, and for connecting the plurality of telephone terminals through the communication network and allowing the plurality of telephone terminals to communicate with each other, the server comprising:
a storage unit that stores in a recording medium a plurality of pieces of registration information indicating that communications are available to be conducted through the communication network in association with identification information indicating each of the plurality of telephone terminals connected to the communication network;
a detection unit that detects whether or not at least one of the plurality of pieces of registration information stored in the recording medium has been erased;
a request transmission unit that transmits, when the detection unit detects that at least one of the plurality of pieces of registration information is erased, a registration information acquisition request to the telephone terminal corresponding to the erased registration information; and
a processing unit that receives the registration information and the identification information sent from the requested telephone terminal in response to the registration information acquisition request and recording the registration information and the identification information in the recording medium.

7. The server according to claim 6, wherein the storage unit stores expiration date information that indicates expiration date of the registration information in association with the identification information in addition to the registration information,
wherein the detection unit detects that the registration information is erased from the recording medium according to the expiration date information, and
wherein when the registration information is erased from the recording medium, the request transmission unit transmits a registration information acquisition request to the corresponding telephone terminal.

8. The server according to claim 6, wherein upon reception of a refusal signal sent from the requested telephone terminal, the processing unit of the server sets the corresponding telephone terminal to an unregistered state.

9. The server according to claim 6, wherein when the registration information and the identification information are unable to be received from the corresponding telephone terminal within a predetermined time period from the timing of sending the acquisition request, the processing unit sets the corresponding telephone terminal to an unregistered state.

10. The server according to claim 6, further comprising an error transmission unit that sends a registration information acquisition request after sending an error message indicating that the communication network is unavailable to be used to the requesting telephone terminal when a request to use the communication network is sent from the telephone terminal being recorded in the recording medium as an unregistered state,
wherein when the registration information and the identification information are sent from the requested telephone terminal in response to the registration information acquisition request, the processing unit records a registration information in the recording medium in association with the corresponding identification information.

11. A telephone terminal for use in a network telephone system having: a plurality of the telephone terminals connected to a communication network; and a server for connecting the plurality of telephone terminals through the communication network and allowing the plurality of telephone terminals to communicate with each other, the telephone terminal comprising:
a voice packet processing unit that converts a voice signal and a voice packet into one another for transmitting the voice packet through the communication network; and
an information transmission unit that transmits the registration information together with the identification information to the server in response to the acquisition request when the acquisition request is sent from the server.

12. The telephone terminal according to claim 11, wherein when an acquisition request is sent from the server, the information transmission unit of the telephone terminal transmits a refusal signal for refusing registration to the server as required.
